(19) United States
(12) Patent Application Publication
(10) Pub. No.: US 2011/0258620 A1
(43) Pub. Date: Oct. 20, 2011

(54) Method and Apparatus for Making a BPM Application Available to Multiple Tenants

(75) Inventors: Bo Gao, Beijing (CN); Chang Jie Guo, Beijing (CN); Tie Jun Ou, Beijing (CN); Wei Sun, Beijing (CN); Qie Yin, (US)

(73) Assignee: INTERNATIONAL BUSINESS MACHINES CORPORATION, Armonk, NY (US)

(21) Appl. No.: 13/075,578

(22) Filed: Mar. 30, 2011

(30) Foreign Application Priority Data
Mar. 31, 2010 (CN) 201010142077.4

(51) Int. Cl. G06F 9/44

(52) U.S. Cl. 717/178

(57) ABSTRACT

A computer-implemented method, an apparatus, and an article of manufacture for making a business process management (BPM) application available to multiple tenants in a multi-tenancy software model. The method includes: obtaining a service level agreement (SLA) as required by a tenant in a multi-tenancy software model, in response to a registration request for the BPM software application from the tenant; selecting a multi-tenancy model based on the obtained SLA; calling a predetermined conversion process corresponding to the selected multi-tenancy software model and disposing BPM software components in the BPM software application, such that the BPM application is made available to the tenant as a multi-tenancy BPM software application; and saving in metadata of the tenant, a result of disposing the BPM software components by the conversion process.

### CROSS-REFERENCE TO RELATED APPLICATIONS

This application claims priority under 35 U.S.C. §119 to Chinese Patent Application No. 201010142077.4 filed Mar. 31, 2010, the entire contents of which are incorporated by reference herein.

### BACKGROUND OF THE INVENTION

1. Field of the Invention

The present invention relates to a Multi-Tenancy technology, and more particularly relates to a method and apparatus for making a BPM software application available to multiple tenants.

2. Description of the Related Art

A prevalent SaaS (Software as a Service) can decrease costs of development, deployment, and operation of a software application through a Multi-Tenancy (MT) technology. The MT technology refers to a technology where a single instance of a software application runs on servers of a service vendor, providing software application services for multiple tenants (organizations such as enterprises).

Conventionally, an independent software vendor (ISV) sells software by licensing, and a user uses a particular software application if it is licensed to the user. Now, the ISV also needs to consider serving more users through SaaS. Therefore, it is necessary to convert a software application that originally supported a licensed user or tenant to a software application that supports multiple licensed users or tenants. Besides requiring technically satisfying a particular MT scenario featuring, for example, resource sharing and security isolation and diverse Service Level Agreements (SLA), this conversion further requires rewriting the original application to the least.

A Business Process Management (BPM) software application is widely applied to serve many small and medium-sized enterprise tenants in an SaaS mode. Because the BPM software application has complex components, converting the BPM software application to a software application that supports multiple tenants is always rather complex.

### SUMMARY OF THE INVENTION

According to an aspect of the present invention, a method is provided for making a business process management (BPM) software application available to multiple tenants in a multi-tenancy software model. The method includes: obtaining, in response to a registration request for the BPM software application from a tenant in a multi-tenancy software model, a service level agreement (SLA) as required by the tenant; selecting a multi-tenancy model based on the obtained SLA; calling a predetermined conversion process corresponding to the selected multi-tenancy software model and disposing BPM software components in the BPM software application such that the BPM software application is made available to the tenant as a multi-tenancy BPM software application; and saving, in metadata of the tenant, the result of disposing the BPM software components by the conversion process.

According to another aspect of the present invention, an apparatus is provided for making a BPM software application available to multiple tenants in a multi-tenancy software model. The apparatus includes: an obtaining module for obtaining, in response to a registration request for the BPM software application from a tenant in a multi-tenancy software model, a service level agreement (SLA) as required by the tenant; a selecting module for selecting a multi-tenancy software model based on the obtained SLA; a converting module for calling a predetermined conversion process corresponding to the selected multi-tenancy software model and for disposing BPM software components in the BPM software application, so that the BPM software application is made available to the tenant as a multi-tenancy BPM software application; and a storing module for saving, in metadata of the tenant, a result of disposing the BPM software components by the conversion process.

According to yet another embodiment of the present invention, an article of manufacture tangibly embodying computer readable instructions which when implemented, causes a computer system to carry out the steps of the method of the present invention.

### BRIEF DESCRIPTION OF THE DRAWINGS

Inventive features that are considered characteristics of the present invention are set forth in the appended claims. However, the present invention, its modes of use, other objectives, features and advantages can be better understood through reading the following detailed description on the exemplary embodiments with reference to the accompanying drawings, where in the drawings:

FIG. 1 illustrates a diagram of a multi-tenancy BPM software application deployment environment according to embodiments of the present invention;

FIGS. 2A-2D are diagrams of several typical multi-tenancy models;

FIG. 3 illustrates a flowchart of one embodiment of the method of the present invention;

FIG. 4 illustrates a flowchart of one embodiment of running a BPM application in real time in an MT manner according to the present invention;

FIG. 5 illustrates a flowchart of another embodiment of running a BPM application in real time in an MT manner according to the present invention; and

FIG. 6 illustrates a schematic block diagram of one embodiment of the apparatus of the present invention.

### DETAILED DESCRIPTION OF THE EMBODIMENTS

Hereinafter, embodiments of the present invention will be described with reference to the accompanying drawings. In the following description, many specific details are illustrated so as to understand the present invention more comprehensively. However, it is apparent to the skilled in the art that implementation of the present invention can be practiced without these details. Additionally, it should be understood that the present invention is not limited to the particular embodiments as introduced here. On the contrary, any arbitrary combination of the following features and elements can be considered to implement and practice the present invention, regardless of whether they involve different embodiments. Thus, the following aspects, features, embodiments and advantages are only for illustrative purposes, and should not be construed as elements or limitations of the appended claims, unless otherwise explicitly specified in the claims.

Converting a BPM software application into an MT software application can be complex and usually requires rewriting the software application. Embodiments of the present invention allows for the modification of codes in the software application to implement techniques of MT software functional details including sharing and isolation, diverse SLAs, and upgrade capability, etc. Embodiments of the present invention provide for the availability of a BPM software application to multiple tenants and to support tenancy-diverse SLAs without many changes of the existing software application. Different multi-tenancy software models are defined for BPM software applications and corresponding conversion methods are provided for BPM software application components. Thus, when a new tenant registers, BPM software application components will be deployed for the new tenant based on the tenant's SLA, so as to enable the BPM software application to be converted into an MT software application with diverse SLAs supported.

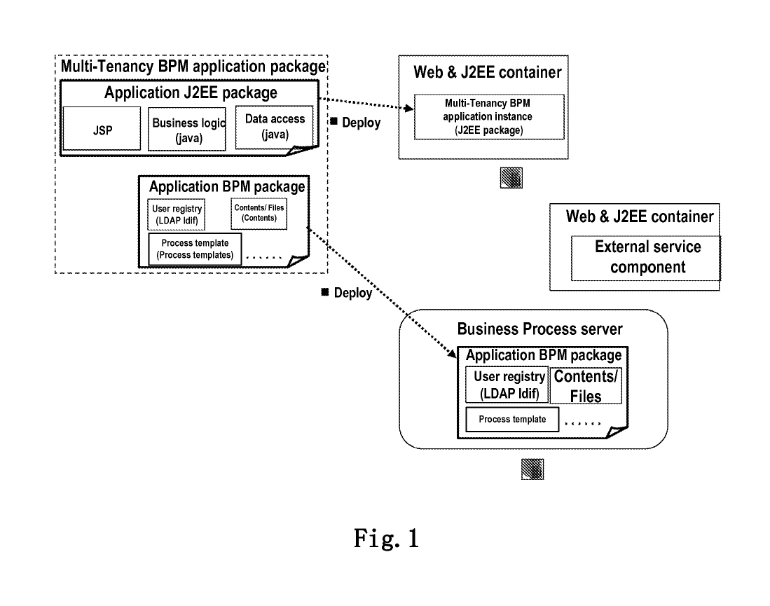

Referring to FIG. 1, schematically illustrates a multi-tenancy BPM software application deployment environment in which embodiments of the present invention can be implemented. As shown in the left side of FIG. 1, in a typical multi-tenancy implementation of a BPM software application, the multi-tenancy BPM software application package is divided into two parts: an application J2EE package and a business process software package or application BPM software package. During deployment, the J2EE package is deployed into a Web&J2EE container (as indicated in the top right part of FIG. 1), and the business process package is deployed into a business process computer server (as indicated in the bottom right part of FIG. 1). An example of the Web&J2EE container is a Web Application Server (WAS), and an example of the business process server is a Websphere Process Server (WPS).

A multi-tenancy BPM application instance in the Web&J2EE container is shared by all tenants. The business process package in the business process server (business process engine) includes a process template, a user registry (as an LDAP Idif file), and other content and/or files, etc. An SLA of a tenant defines a service level provided for the tenant. The tenancy-diverse SLA results in different requirements on deployment of the business process package. In order to enable the BPM application to support multiple tenants, it is required to process BPM application components relating to or affecting the SLA, for satisfying particular requirements of a particular tenant.

BPM application components affecting the SLA usually include a process template and a user registry. Those skilled in the art know that the process template defines a business process for a business software application, which describes particular business logic and can be used to create a business process instance in a running environment. The user registry usually adopts a form of LDAP (Light Directory Access Protocol) idif file, for storing account information of the user, such as user ID (identifier) and logon password etc. Users in the user registry of a tenant are assigned roles that are to be played during executing a business process of this tenant, such as a manager role, an administrator role for processing abnormalities, etc. Processes for BPM application components so as to support multiple tenants have different combinational manners, i.e., different multi-tenancy models.

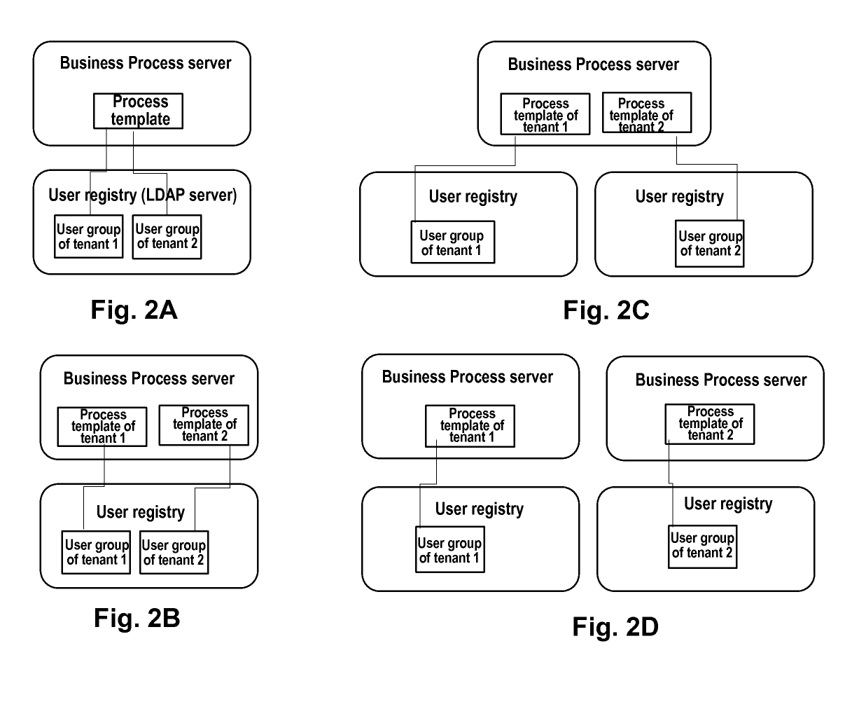

Now, referring to FIGS. 2A-2D for a diversity of typical multi-tenancy models, these figures exemplarily define some typical BPM software application multi-tenancy models (in the case of a clear context, they are also briefly called “multi-tenancy models” or “models”).

Model A: sharing a process template and separating user registries. According to this model, in addition to an application instance in the J2EE container that is shared by all tenants, the process template in the process server is also shared by all tenants; the user registries of the tenants are separate. FIG. 2A illustrates model A, where tenant 1 and tenant 2 share a process template in the process server, but their user registries are separate and have their own LDAP sub-trees (for example, in an LDAP server): “user group of tenant 1” and “user group of tenant 2.”

Model B: separating process templates in the same process engine and separating user registries. According to this model, all tenants share a process engine, and each tenant individually has a process template in the process engine; the user registries of the tenants are separate. This model is illustrated in FIG. 2B, where tenant 1 and tenant 2 have a separate process template in the process server: “process template of tenant 1” and “process template of tenant 2,” and have their own LDAP subtrees: “user group of tenant 1” and “user group of tenant 2.”

Model C: separating process templates in the same process engine and separating user registries in dedicated servers. According to this model, all tenants share a process engine, and each tenant individually has a process template in the process engine; the user registries of the tenants are separate. This model is illustrated in FIG. 2C, where tenant 1 and tenant 2 have a separate process template in the process server: “process template of tenant 1” and “process template of tenant 2,” and have a LDAP tree in their respective LDAP servers: “user group of tenant 1” and “user group of tenant 2.”

Model D: separating process templates in dedicated process engines and separating user registries in dedicated servers. According to this model, each tenant has its own independent process engine, and each tenant individually has a process template in the respective process engine; the user registries of the tenants are separate. FIG. 2D clearly illustrates the above features of Model D.

Those skilled in the art should know that besides the process template and the user registry, BPM application components affecting the SLA can further include an external data access component (or an external service component). The business process can call a component external to the business process with the external data access component in various manners so as to perform the business operation.

Therefore, according to embodiments of the present invention, further multi-tenancy models can be constructed on the basis of the above models. For example, model A′=model A+sharing an external data access component that supports multi-tenancy; model B′=model B+sharing an external data access component that supports multi-tenancy; model C′=model C+sharing an external data access component that supports multi-tenancy; model D′=model D+each tenant having its own external data access component that does not support multi-tenancy sharing. Those skilled in the art know that more multi-tenancy models can be further constructed as required.

The diversity of the BPM multi-tenancy models reflects the diversity of the SLA. Due to the diversity of the SLA, to enable a BPM application to support an MT application scenario requires a programmer to perform complex modification to a code in the BPM application for a new tenant frequently, which thus has a rather low efficiency.

According to embodiments of the present invention, a corresponding conversion process is also pre-provided after constructing different BPM multi-tenancy models. For different BPM multi-tenancy models, the conversion process disposes components in the BPM application, such as the process template, the user registry, and the external data access component. In this way, when a user requires registration to become a tenant of a BPM application, a conversion method can be called at any time as required by the SLA to deploy the components in the BPM application so that the BPM application can provide services to tenants in an MT application manner.

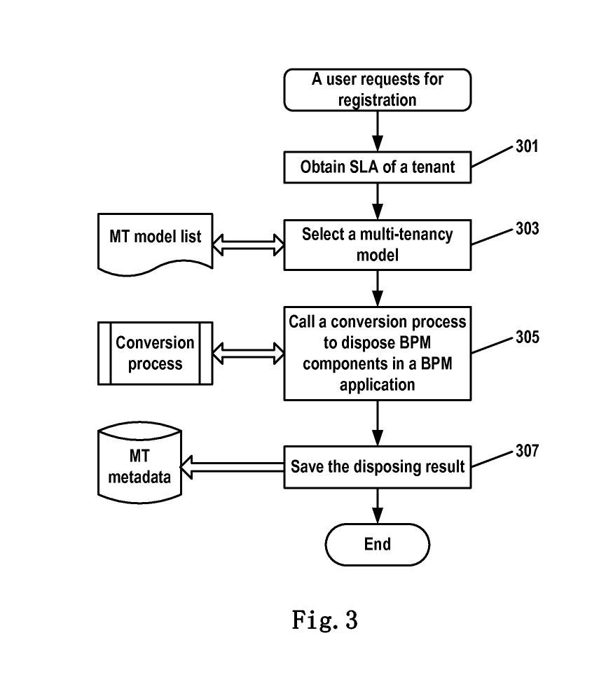

Referring to FIG. 3, this figure exemplarily illustrates a processing process performed upon registration of a new tenant according to an embodiment of the method of the present invention.

At step 301, a service level agreement (SLA) as required by a tenant is obtained in response to a registration request for the BPM application from the tenant. For example, a user representing a tenant can input an SLA through a UI or select a required SLA from an SLA list.

At step 303, a multi-tenancy model is selected based on the obtained SLA. According to an embodiment of the present invention, a multi-tenancy model can be selected from a list of multi-tenancy models, where the list of multi-tenancy models predefines multi-tenancy models corresponding to various kinds of SLAs.

At step 305, a predetermined conversion process corresponding to the selected multi-tenancy model is called to dispose BPM components in the BPM application such that the BPM application can be made available to the tenant as a multi-tenancy BPM application.

According to an embodiment of the present invention, a conversion method is first provided for various kinds of BPM multi-tenancy models before the BPM application provides services in a multi-tenancy application manner. This conversion method can be programmed as a called program or a conversion process. For different BPM multi-tenancy models, the conversion method or conversion process disposes BPM components in a BPM application, such that the BPM application can be made available to multiple tenants as a multi-tenancy BPM application.

According to another embodiment of the present invention, step 305 of disposing BPM components includes the case where the selected multi-tenancy model requires separate user registries, the conversion process distinguishes user registries by identifiers of the tenants.

For example, Model A is defined as sharing the process template and separating the user registries. With respect to Model A, the conversion method performs the process of isolating the user registries to components in the BPM application, e.g., the user registries and the process template. The process can be achieved by distinguishing a user registry of each tenant, for example, by an identifier of the tenant (or a tenant name)<Tenant_ID> in the user registry name <User_Registry_Name> as a prefix, for example <Tenant_ID>“-”<User Registry Name>. In this way, a newly registered tenant will have a separate user registry. No special processing is required for the process template of Model A. Isolation of the process template will be guaranteed during running of the system.

According to another embodiment of the present invention, step 305 of disposing BPM components includes the case where the selected multi-tenancy model requires separate process templates, the conversion process distinguishes process templates by the identifiers of the tenants.

For example, Model B is defined as separating the process templates in the same process engine and separating the user registries. With respect to Model B, the conversion method performs the process of isolating the user registries to components in the BPM application, e.g., the user registries and the process templates. The process can be achieved by distinguishing a user registry of each tenant, for example, by a tenant name <Tenant_ID> in the user registry name <User_Registry_Name> as a prefix, for example, <Tenant_ID>“-”<User_Registry_Name>. In this way, a newly registered tenant will have a separate user registry. The process templates are further isolated. This can be achieved by distinguishing a process template of each tenant, for example, by a tenant name <Tenant_ID> in the template name <Process_Template_Name> as a prefix, for example <Tenant_ID>“-”<Process_Template_Name>. In this way, a newly registered tenant will have a separate process template.

According to another embodiment of the present invention, step 305 of disposing BPM components includes selecting corresponding servers for the BPM components so as to deploy the BPM components, and the disposed result of the BPM member by the conversion process includes names of the BPM components and names of the selected corresponding servers.

For example, Model D is defined as separating the process templates in dedicated process engines and separating the user registries in dedicated servers. With respect to Model D, the conversion method performs the following processing to components in the BPM application, e.g., the user registries and the process templates. A dedicated server, for example, an LDAP server, is selected to deploy the user registry on the dedicated server. In this way, a newly registered tenant will have a separate user registry on the dedicated server. A dedicated process engine server is selected to “clone” the process template on the dedicated process engine server. In this way, the newly registered tenant will have a separate process template on the dedicated process engine server.

As another example, Model A′ is defined as Model A+ sharing an external data access component that supports multiple tenants. Thus, with respect to Model A′, processing of the conversion method to components in the BPM application includes: performing similar processing on the user registries and the process template as those with respect to Model A; in addition, for a component accessing external data, the conversion method needs no processing and the component accessing external data will be managed by the component itself.

The above illustrations on conversion methods or conversion processes for different models are only schematic. Through the above exemplary introductions, those skilled in the art can provide a corresponding conversion method for a BPM multi-tenancy model according to a specific definition on the BPM multi-tenancy model. As those skilled in the art should understand, the server as mentioned above can refer to either a physical server or a virtual server. For example, in a specific implementation, the business process server and the LDAP server can be implemented on different server entities or implemented on one server entity.

At step 307, the result of disposing the BPM component by the conversion process is saved in the metadata of the tenant.

According to an embodiment of the present invention, the above disposing result, such as the user registry of the new tenant <tenant-ID>“-”<User Registry Name>, the process template of the new tenant <Tenant_ID>“-”<Process_Template_Name>, the LDAP server selected for the user registry of the new tenant, and the process engine server selected for the process template of the new tenant, will be stored as metadata of the new tenant.

The process as illustrated in FIG. 3 can be repeated for each new tenant registration. Because various kinds of multi-tenancy models have been pre-defined and a conversion process callable upon tenant registration has been pre-designed for various kinds of models, the workload for modifying a BPM application program for each new tenant can be reduced.

When a user of a registered tenant is running the BPM application, the system will route and isolate a tenant request based on the current tenant and the multi-tenancy model selected upon its registration (for example through an MT-extended BPM API and running components).

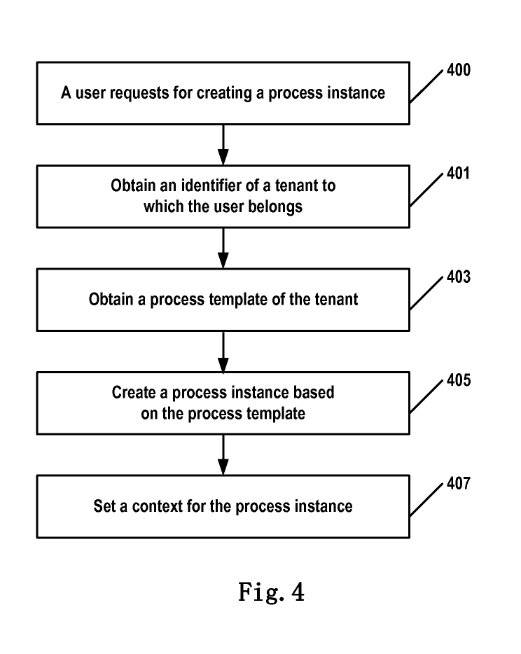

Hereinafter, an embodiment of running a BPM application in real time in an MT manner according to the present invention will be described with reference to FIG. 4. This figure schematically illustrates a flow of processing a request for creating a process instance by a user of a registered tenant.

As illustrated in the figure, the process begins with step 400, where the user issues a request for creating a process instance. In response to the request, at step 401, an identifier of the registered tenant to which the user belongs is obtained.

In a specific embodiment according to the present invention, various manners can be selected to obtain the identifier of a registered tenant to which the user belongs, which can be obtained from the request of the user, for example, obtained from the information required to be inputted when the user logs on.

At step 403, the process template deployed by the tenant on a predetermined server is obtained from the metadata of the tenant. As mentioned in the illustration on the embodiment of FIG. 3, the name of the process template and the name of the corresponding server have been saved in the metadata of each registered tenant. Therefore, through the identifier of the tenant, the process template deployed by the tenant on the predetermined server can be obtained from the metadata of the tenant.

At step 405, a process instance is created based on the obtained process template. At step 407, a tenant context is set for the created process instance. For example, a tenant identifier is set for a thread of the process instance.

The above embodiment illustrates the use of disposing the result of the BPM components as saved at step 307 in the process as illustrated in FIG. 3. The process of creating a process instance for a registered tenant is well known to those skilled in the art, which will not be described in detailed here.

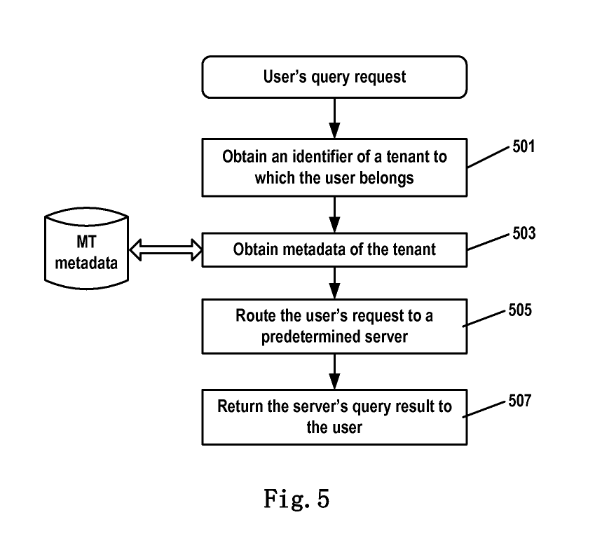

FIG. 5 illustrates a flowchart of another embodiment of running a BPM application in an MT manner according to the present invention. This embodiment schematically illustrates a processing on a query request from a user of a registered tenant.

As illustrated in the figure, at step 501, in response to a query request from a user, an identifier of the registered tenant to which the user belongs is obtained from the request of the user. At step 503, metadata of the registered tenant is obtained. At step 505, the request of the user is routed to a predetermined server based on the metadata of the registered tenant.

At step 507, a query result is returned. According to one embodiment of the present invention, before sending the query result returned from the predetermined server to the user issuing the query request, it is necessary to filter out content irrelevant to the registered tenant from the query result of the server. In a multi-tenancy environment, the content irrelevant to the registered tenant, for example, is content belonging to the other tenant.

The above embodiment of implementing simple functions illustrates a scenario where a BPM application registered according to the method of embodiments of the present invention is used as a multi-tenancy application, where filtering the query result from the server embodies one aspect of the characteristics of the multi-tenancy application.

A method of making a BPM application available to multiple tenants according to embodiments of the present invention has been described above. The above depiction is only exemplary and not intended for limiting the present invention. In other embodiments of the present invention, this method can have more, or less, or different steps, and the sequence of respective steps can also be different from the depiction. For example, in some embodiments, the above one or more optional steps can be omitted. Specific embodiments of each step can be different from the depiction. All these variations fall within the spirit and scope of the present invention.

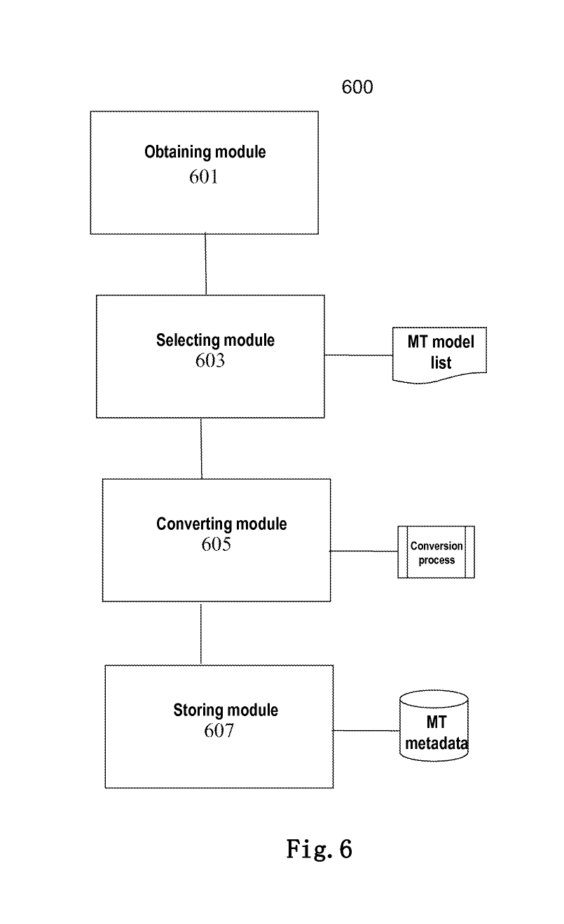

According to another embodiment of the present invention, an apparatus is provided for making a BPM application available to multiple tenants. Hereinafter, an apparatus for making a BPM application available to multiple tenants according to an embodiment of the present invention will be described with reference to FIG. 6.

As illustrated in the figure, the apparatus 600 includes: an obtaining module 601, a selecting module 603, a converting module 605, and a storing module 607.

The obtaining module 601 is configured to obtain a service level agreement SLA as required by a tenant, in response to a registration request for the BPM application from the tenant. The selecting module 603 is configured to select a multi-tenancy model based on the SLA. The converting module 605 is configured to call a predetermined conversion process corresponding to the multi-tenancy model and to dispose BPM components in the BPM application such that the BPM application is available as a multi-tenancy BPM application. The storing module 607 is configured to save in the metadata of the tenant' SLA, the result of disposing the BPM components by the conversion process.

For example, according to an embodiment of the present invention, the selecting module 603 can select a multi-tenancy model from a list of multi-tenancy models, where the list of multi-tenancy models predefines multi-tenancy models corresponding to various kinds of SLAs.

According to an embodiment of the present invention, the BPM components disposed by the converting module 605 include at least a process template and a user registry and can further include an external data access component.

According to another embodiment of the present invention, the conversion process called by the converting module 605 distinguishes individual user registries by identifiers of the tenants, or/and distinguishes individual process templates by identifiers of the tenants.

According to still another embodiment of the present invention, the conversion process called by the converting module 605 selects a corresponding server for a BPM component so as to deploy the BPM component. For example, the conversion process called by the converting module 605 selects a corresponding server for the process template, for example a business process server, so as to deploy the process template, or/and selects a corresponding server for the user registry, for example an LDAP server, so as to deploy the user registry; correspondingly, the storing module 607 is further configured to save in the metadata of the tenant the name of the process template and the name of the corresponding server, or/and to save the user registry and the name of the corresponding server.

The apparatus 600 and its various embodiments described above can be used to perform the above mentioned method of making a BPM application available to multiple tenants. For the sake of simplicity, in the above depiction on the apparatus 600 and its various embodiments, some content repetitive to the above depiction on the corresponding method is omitted. Therefore, details of this apparatus can be understood with reference to the above depiction on the corresponding method. Therefore, the above depiction and diagrams on the apparatus 600 and its various embodiments are only exemplary, not for limiting the present invention. In other embodiments of the present invention, this apparatus can have more, or less, or different modules, and connection or inclusive relationship between respective modules can also be different from what is depicted and illustrated.

For example, as those skilled in the art should understand, the server as called herein can be either physical or virtual. For example, in a specific embodiment of the present invention, the business process engine server and the LDAP server can be implemented on different server entities or on a single server entity.

The present invention can be implemented by hardware, software, or combination of hardware and software. The present invention can be implemented in a computer system in a collective or distributive manner, where in the distributive manner, different parts are distributed in a plurality of interconnected computer systems. Any computer system or other apparatus suitable for implementing the method as depicted herein is suitable. A typical combination of hardware and software can be a universal compute system with a computer program which, when being loaded and executed, controls the computer system to implement the method of the present invention and constitute the apparatus of the present invention.

The present invention can also be embodied in a computer program product which includes all features capable of implementing the method as depicted herein and can implement the method when loaded to the computer system.

Although the present invention has been specifically illustrated and explained with reference to the preferred embodiments, those skilled in the art should understand various changes can be made thereto in form and details without departing from the spirit and scope of the present invention.

What is claimed is:

1. A computer-implemented method of making a business process management (BPM) software application available to multiple tenants in a multi-tenancy software model, comprising:
obtaining a service level agreement (SLA) as required by a tenant in a multi-tenancy software model, in response to a registration request for the BPM software application from the tenant;
selecting a multi-tenancy software model based on the obtained SLA;
calling a predetermined conversion process corresponding to the selected multi-tenancy software model to dispose BPM software components in the BPM software application such that the BPM software application is made available to the tenant as a multi-tenancy BPM software application; and
saving, in metadata of the tenant, the result of disposing the BPM software components by the conversion process.

2. The method according to claim 1, wherein the selected multi-tenancy software model is selected from a list of multi-tenancy software models which predefines multi-tenancy software models corresponding to various SLAs.

3. The method according to claim 1, wherein the BPM software components is selected from the group consisting of: a process template and a user registry.

4. The method according to claim 3, wherein the BPM software components further comprise an external data access component.

5. The method according to claim 3, wherein the selected multi-tenancy software model requires a separate user registry, and the conversion process distinguishes the user registry by an identifier of the tenant.

6. The method according to claim 3, wherein the selected multi-tenancy software model requires a separate process template, and the conversion process distinguishes the process template by an identifier of the tenant.

7. The method according claim 3, wherein:
the step of calling a predetermined conversion process corresponding to the selected multi-tenancy software model to dispose BPM software components in the BPM software application comprises selecting a corresponding computer server for the BPM software components so as to deploy the BPM software components, and
the disposed result of the BPM software components by the conversion process comprises the name of the BPM software components and the name of the selected corresponding computer server.

8. The method according claim 4, wherein:
the step of calling a predetermined conversion process corresponding to the selected multi-tenancy software model to dispose BPM software components in the BPM software application comprises selecting a corresponding computer server for the BPM software components so as to deploy the BPM software components, and
the disposed result of the BPM software components by the conversion process comprises the name of the BPM software components and the name of the selected corresponding computer server.

9. The method according to claim 7, further comprising:
obtaining an identifier of a registered tenant to which a user belongs, in response to a request for creating a process instance from the user;
obtaining a corresponding process template deployed by the registered tenant on a predetermined computer server from the metadata of the registered tenant;
creating a process instance based on the obtained process template of the registered tenant; and
setting a tenant context for the created process instance.

10. The method according to claim 1, further comprising:
obtaining an identifier of a registered tenant to which a user belongs, in response to a query request from the user;
obtaining metadata of the registered tenant;
routing the query request of the user to a predetermined computer server based on the metadata of the registered tenant;
filtering out content irrelevant to the registered tenant in a query result of the computer server; and
returning the filtered query result to the user.

11. An apparatus for making a business process management (BPM) software application available to multiple tenants in a multi-tenancy software model, comprising:
an obtaining module, configured to obtain a service level agreement (SLA) as required by a tenant in a multi-tenancy software model, in response to a registration request for the BPM software application from the tenant;
a selecting module, configured to select a multi-tenancy software model based on the SLA;
a converting module, configured to call a predetermined conversion process corresponding to the selected multi-tenancy software model and to dispose BPM software components in the BPM software application such that the BPM software application is made available as a multi-tenancy BPM software application; and
a storing module, configured to save, in metadata of the tenant, a result of disposing the BPM software components by the conversion process.

12. The apparatus according to claim 11, wherein the selecting module is further configured to select the multi-tenancy software model from a list of multi-tenancy software models which predefines multi-tenancy software models corresponding to various SLAs.

13. The apparatus according to claim 11, wherein the BPM software components is selected from the group consisting of: a process template and a user registry.

14. The apparatus according to claim 13, wherein the BPM software components further comprise an external data access component.

15. The apparatus according to claim 13, wherein the selected multi-tenancy software model requires a separate user registry, and the conversion process distinguishes the user registry by an identifier of the tenant.

16. The apparatus according to claim 13, wherein the selected multi-tenancy software model requires a separate process template, and the conversion process distinguishes the process template by an identifier of the tenant.

17. The apparatus according to claim 13, wherein:
the converting module calls the predetermined conversion process by selecting a corresponding computer server for the process template to deploy the process template, and
the storing module is further configured to save, in the metadata of the tenant, the name of the process template and the name of the corresponding computer server.

18. The apparatus according to claim 13, wherein:
the converting module calls the predetermined conversion process by selecting a corresponding computer server for the user registry to deploy the user registry, and
the storing module is further configured to save, in the metadata of the tenant, the name of the user registry and the name of the selected corresponding computer server.

19. An article of manufacture tangibly embodying computer readable instructions which when implemented, causes a computer system to perform the steps of a computer-implemented method for making a business process management (BPM) software application available to multiple tenants in a multi-tenancy software model, said steps comprising:
obtaining a service level agreement (SLA) as required by a tenant in a multi-tenancy software model, in response to a registration request for the BPM software application from the tenant;
selecting a multi-tenancy software model based on the obtained SLA;
calling a predetermined conversion process corresponding to the selected multi-tenancy software model to dispose BPM software components in the BPM software application such that the BPM software application is made available to the tenant as a multi-tenancy BPM software application; and
saving, in metadata of the tenant, the result of disposing the BPM software components by the conversion process.
